(19) United States
(12) Patent Application Publication
(10) Pub. No.: US 2005/0098481 A1
(43) Pub. Date: May 12, 2005

(54) Fractionation or screening device

(76) Inventors: Gerd Reisner, Peggau (AT); Heribert Low, Graz (AT); Helmuth Gabl, Graz (AT)

Correspondence Address: ALIX YALE & RISTAS LLP, 750 MAIN STREET, SUITE 1400, HARTFORD, CT, 06103, US

(21) Appl. No.: 10/966,582

(22) Filed: Oct. 15, 2004

(30) Foreign Application Priority Data
Oct. 15, 2003 (AT) A 1624/2003

(51) Int. Cl. B07B 1/00; B03B 1/00

(52) U.S. Cl. 209/1

(57) ABSTRACT

The inventions relates to a fractionation or screening device with a fractionation or screening structure and a bearing or support for mounting the fractionation or screening structure on a rigid machine base. The bearing or support has greater compliance than the fractionation or screening structure itself, thus excess stress can be avoided in the fractionation or screening structure.

### BACKGROUND OF THE INVENTION

This invention relates generally to fractionation or screening devices. More particularly, the present invention relates to fractionation or screening structures bearings or supports for mounting the fractionation or screening structure on a rigid machine base.

In conventional technology, fractionation or screening structures are supported using mechanical engineering methods in such a way that the bearing or support has the most rigid design possible. This means that the bearing or support can be considered unyielding in relation to the fractionation or screening structure, which causes considerable excess stresses around the bearing points of the fractionation or screening structure when forces are applied to it. These excess stresses often occur in rough industrial operations and are caused, for example, by vibrations, by shaking as a result of unbalanced rotating parts, etc. The excess stresses can substantially reduce the service life of the entire fractionation or screening structure.

FIG. 1 shows the conventional bearing or support assembly for a screen basket 1, as used in the pulp and paper industry, as well as the stresses occurring in the screen basket 1 during operation, shown as stress curves 4 running along the length of the screen basket. The screen basket 1 is welded to a machine base 2 (see welding points 3). The welding points 3 form a rigid (unyielding) bearing or support. The term machine base 2 can also mean or consist of an intermediate piece, which itself is also secured by a rigid connection to a support. The stress curve 2 shows the substantial excess stresses in the screen basket 1 at its bearing points.

### SUMMARY OF THE INVENTION

The present invention offers a solution to the problems with state-of-the-art technology as described above, where the fractionation or screening device mentioned at the beginning is further developed in such a way that the bearing or support with which the fractionation or screening structure is mounted on a rigid machine base has greater compliance than the fractionation or screening structure itself.

In one embodiment of the invention the supporting elements are made of materials with a smaller E-module than the material of the fractionation or screening structure. It is an advantage if flexible materials, e.g. polymers, particularly rubber, are used for the supporting elements. The fractionation or screening structure is made largely of metal, particularly stainless steel, with E-module values between 190,000 and 210,000 MPa.

In a favorable embodiment of the invention from the manufacturing point of view and one which would also facilitate assembly, the supporting elements are shaped to fit the fractionation or screening structure, where the supporting elements are preferably shaped in a suitable way to be held with positive locking in a bearing or support element of the machine base. At the same time, the supporting elements can also take on the function of sealing elements, particularly if they are made of rubber or similar material. The supporting elements can also be connected to separate sealing elements.

In an alternative configuration, the supporting elements are designed as spring elements, where the spring elements can be made of the same material as the fractionation or screening structure. The spring elements can also be designed as sealing elements or connected to sealing elements.

### BRIEF DESCRIPTION OF THE DRAWINGS

The present invention may be better understood and its numerous objects and advantages will become apparent to those skilled in the art by reference to the accompanying drawings in which:

FIG. 1 is a longitudinal section view through a screen basket in a conventional bearing or support, as well as the stresses occurring in the screen basket;

FIG. 2 is a longitudinal section through a screen basket in a bearing or support according to the invention, as well as the stresses occurring in the screen basket;

FIG. 3 is a partial cross-section through a bar-type screen basket in a conventional bearing or support;

FIG. 4 is a partial cross-section through a bar-type screen basket in a bearing or support according to the invention;

FIG. 5 is a detail of a bar-type screen basket according to the invention;

FIG. 6 is a partial view of a bar-type screen basket according to the invention in a bearing or support according to the invention;

FIG. 7 is a partial view of a bar-type screen basket according to the invention in another bearing or support according to the invention;

FIG. 8 is a second embodiment of a bar-type screen basket in a bearing or support according to the invention;

FIG. 9 is a diagram of the stress progression in the bar-type screen basket in the conventional bearing or support shown in FIG. 3; and

FIG. 10 is a diagram of the stress progression in the bar-type screen basket in the bearing or support according to the invention as shown in FIG. 4.

### DETAILED DESCRIPTION OF THE PREFERRED EMBODIMENT

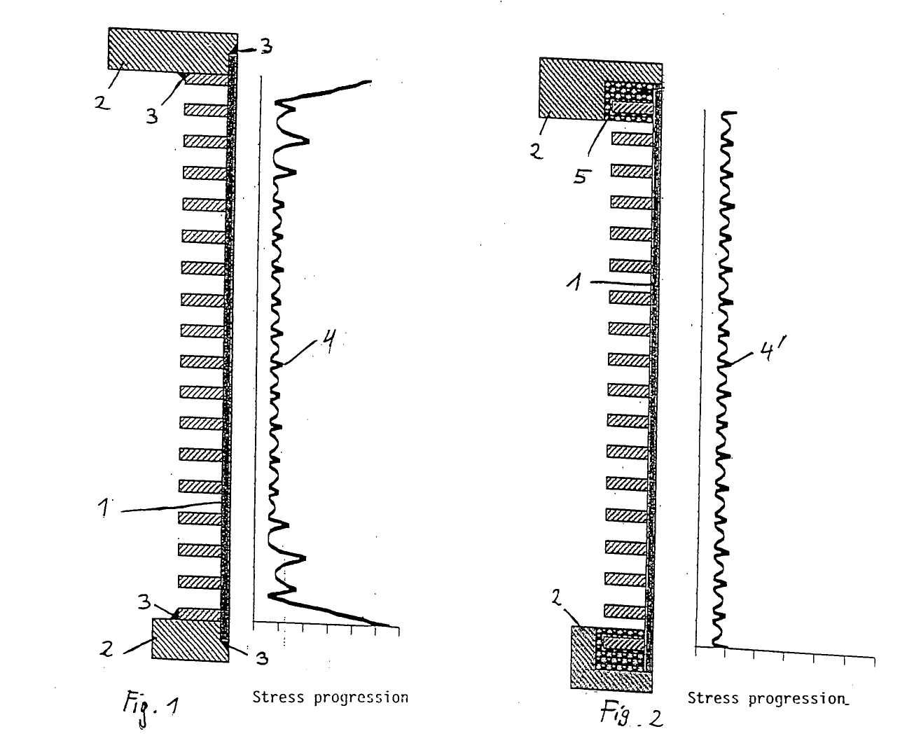

Due to the measures according to the invention, the stress progression in the fractionation or screening structure is much more even than it would be with a state-of-the-art bearing or support. The advantages of the invention are illustrated in FIG. 2, which shows the screen basket 1 from FIG. 1 in a bearing or support according to the invention, where the screen basket 1 is secured to the machine base 2 with an elastic supporting element 5. The supporting element 5 has greater compliance than the screen basket 1, which results in a more even stress progression, as is shown in the stress curve 4′. This curve 4′ shows that there are no excess stresses at all at the bearing points and that an even stress progression is obtained instead over the entire length of the screen basket 1.

The term “compliance” should be understood here as displacement of the loading point when a force is applied to it. The higher the compliance, the greater the displacement of the loading point at a pre-set force. The compliance depends on the E-module of the material used and on the geometry. Displacement of the loading point is reversible in nature, i.e. there is no permanent deformation of the machine components mentioned as part of its dedicated purpose, which was taken into account in its design by selecting suitable materials and sizing the parts appropriately. When there is no load, the equipment returns to its original status.

As shown above, the invention reduces the excess stress in the vicinity of the bearing or support of the fractionation or screening structure, or even eliminates it entirely. As a result, the equipment has a longer service life, or it is also possible to use a less sturdy design in sizing the fractionation or screening structure, thus providing substantial cost savings. The cost saving relates both to the material used and to the reduced fabrication work input.

The fractionation or screening structure can preferably comprise screen baskets, fractionation baskets, as well as bow-screen, flat screen, inclined screen, corrugated screen surfaces, etc., as used in the pulp and paper industry.

As already explained using FIG. 2, the increased compliance of the bearing or support in relation to the fractionation or screening structure can be achieved by using compliant supporting elements in the bearing or support.

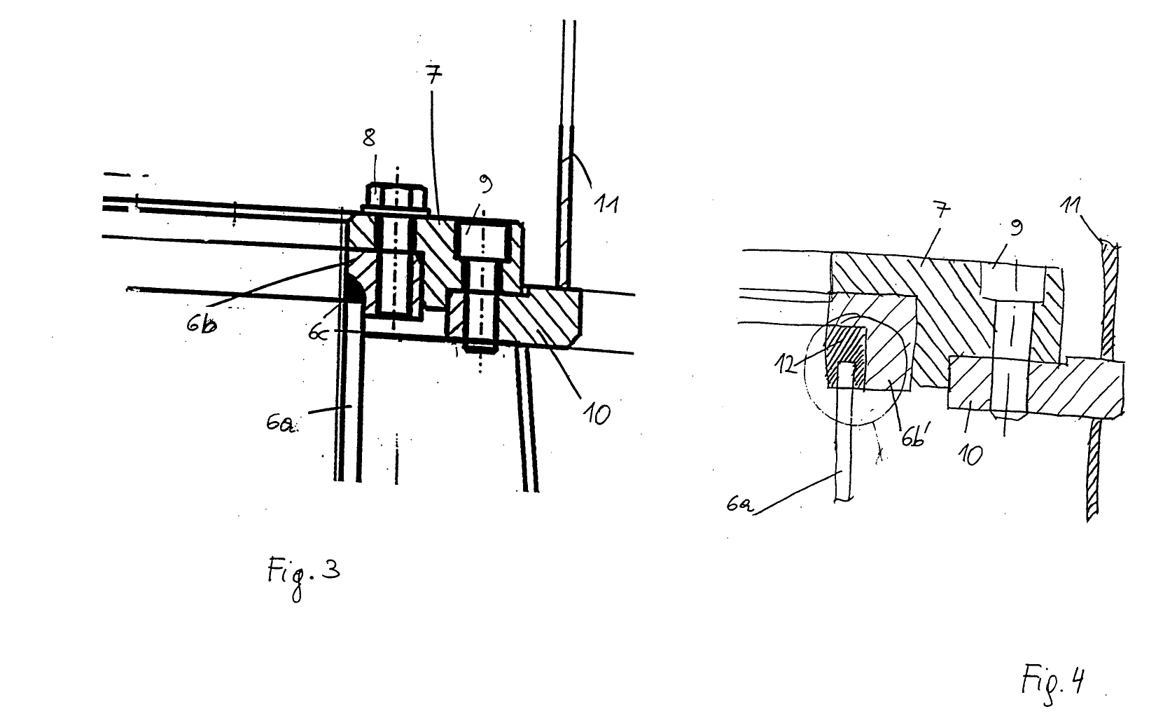

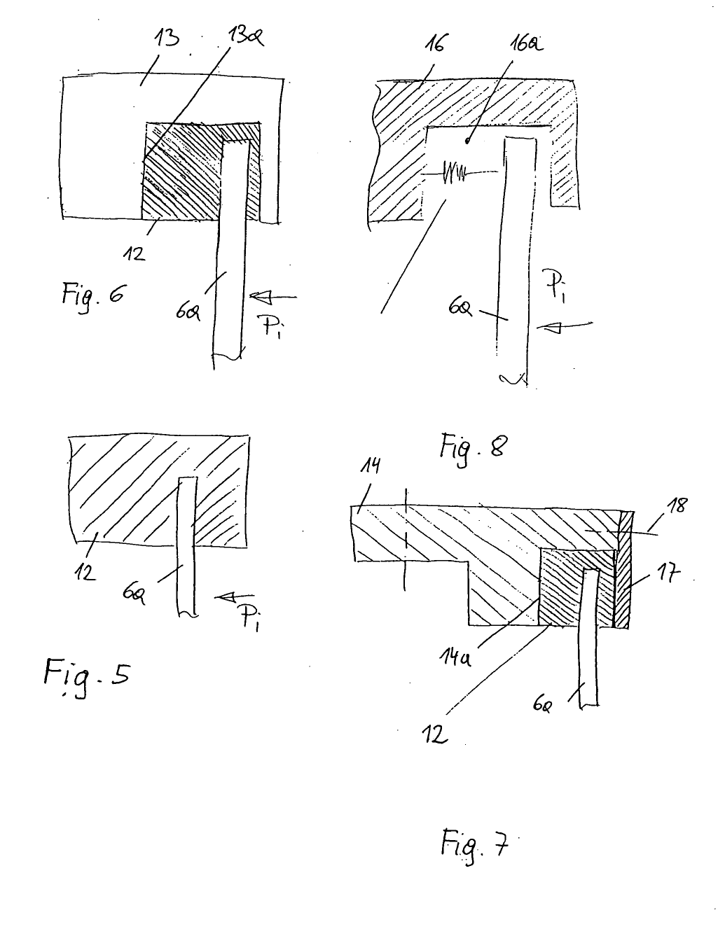

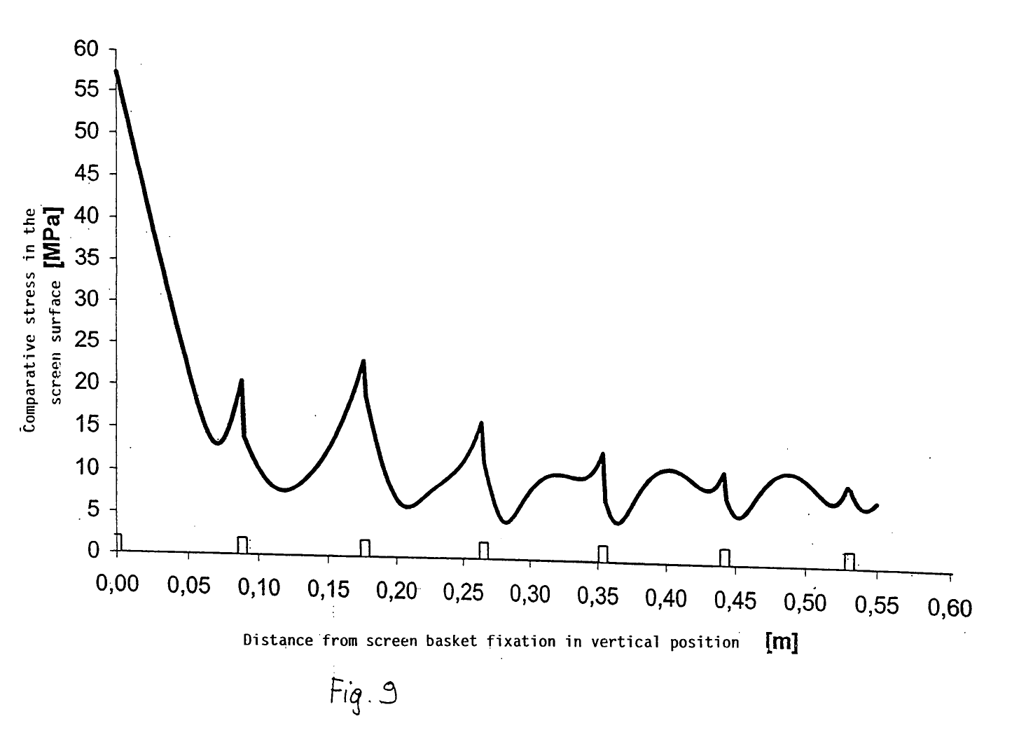

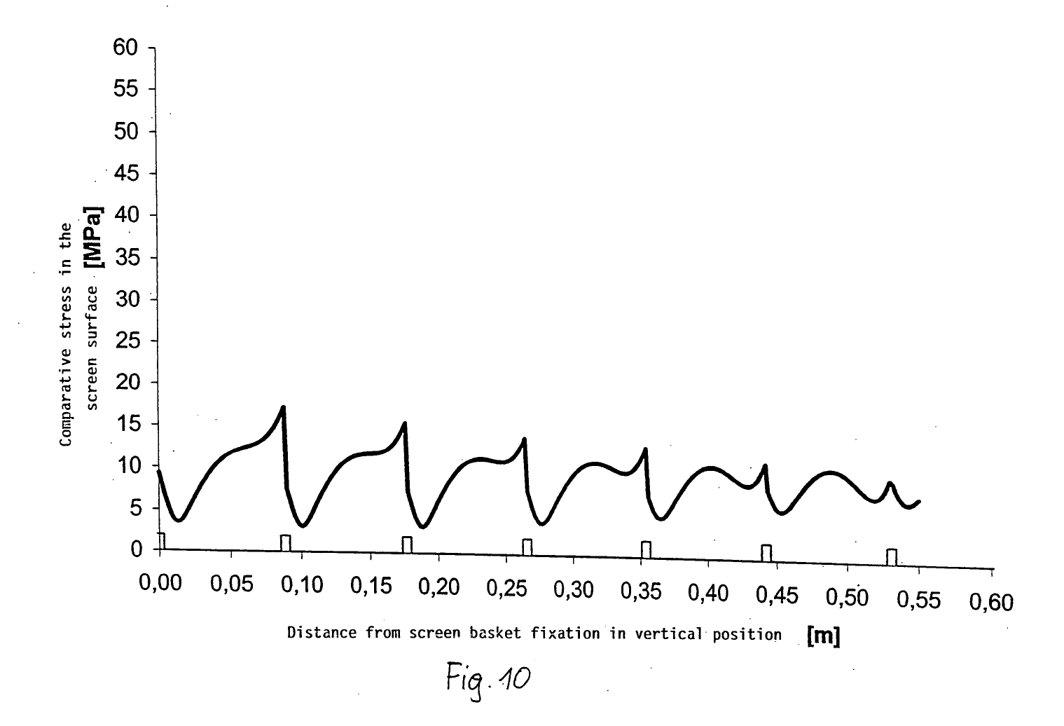

Referring to FIG. 3, this illustration shows a fractionation or screening structure in the form of a bar-type screen basket of the kind used in screens in the pulp and paper industry. The bar-type screen basket comprises a large number of bars 6a made of stainless steel, which are welded (at 6c) parallel to one another round the circumference of a ring 6b, where the ring 6b is designed as an annular flange. The annular flange 6b is connected to an intermediate ring 7 by bolts 8, where the intermediate ring is again connected by bolts 9 to a machine base in the form of a housing flange 10, which is part of the housing 11 for the screen. The annular flange 6b has the function of a bearing or support for the bars 6a, where the bar support should be considered unyielding or rigid due to the weld seam 6c. Similarly, the screw fitting between the annular flange 6b with the intermediate ring 7 and the housing flange 10 is also a rigid bearing or support. The stresses occurring in the bar-type screen basket when in use are illustrated in the diagram in FIG. 9, which shows the stresses in MPa occurring in the bars 6a over their length in m (meters), starting from the weld point 6c (=0.0 mm). The illustration clearly shows that the 55 MPa stress occurring at the weld point is more than several times the average stresses, which of course shortens the service life of the screen basket or requires a very robust and thus, expensive screen basket design.

FIG. 4 shows a further development of the bar-type screen basket according to the invention and as shown in FIG. 3. This differs from the embodiment in FIG. 3 in that the bars 6a are no longer flanged directly onto the annular flange, but cast into a ring-shaped supporting element 12 made of a polymer, e.g. caoutchouc. The supporting element 12 is again adapted to fit into a ring-shaped recess in the annular flange 6b′ and acts as a sealing ring at the same time. In turn, the annular flange 6b′ is adapted to fit into the intermediate ring 7 in a way that is already known (or bolted to the ring with bolts that are not shown). The intermediate ring 7 forms a rigid connection by means of bolts 9 to the housing flange 10 of the housing 11. The diagram in FIG. 10, which illustrates in MPa the stresses occurring in the bars 6a in this embodiment according to the invention as a function of the bar length in meters, shows immediately the extent of the advantage provided according to the invention by the compliant bearing or support for the bars in the bar-type screen basket because the stresses occurring at the bearing points, i.e. at the ends of the bars cast into the supporting element 12, are barely larger than further along the length of the bars. This results in a substantially longer service life for the bar-type screen basket according to the invention compared to the bar-type screen baskets already known.

In one embodiment of the invention, the screen basket bars can be welded onto the annular flange—as in the embodiment already known—however the annular flange can also be connected to the intermediate ring or a machine base via a compliant supporting element. A further point to mention is that the screen basket may consist of perforated plates instead of individual bars, where the edges of these plates are held in the supporting elements.

In one embodiment of the invention the supporting elements are made of materials with a smaller E-module than the material of the fractionation or screening structure. It is an advantage if flexible materials, e.g. polymers, particularly rubber, are used for the supporting elements. The fractionation or screening structure is made largely of metal, particularly stainless steel, with E-module values between 190,000 and 210,000 MPa.

In a favorable embodiment of the invention from the manufacturing point of view and one which would also facilitate assembly, the supporting elements are shaped to fit the fractionation or screening structure, where the supporting elements are preferably shaped in a suitable way to be held with positive locking in a bearing or support element of the machine base. At the same time, the supporting elements can also take on the function of sealing elements, particularly if they are made of rubber or similar material. The supporting elements can also be connected to separate sealing elements.

In an alternative configuration, the supporting elements are designed as spring elements, where the spring elements can be made of the same material as the fractionation or screening structure. The spring elements can also be designed as sealing elements or connected to sealing elements.

In FIG. 5, an enlarged view of the screen structure is shown in the form of screen basket bars 6a cast into the polymer supporting rod 12. Transverse forces Pi acting on the bars 6a are deflected via the compliant supporting rod 12 and transmitted to a machine base.

FIG. 6 shows a variant of an annular flange 13 to hold the screen structure in FIG. 5. The annular flange 13 has a revolving groove 13a that is dimensioned such that the supporting rod 12 can be held there to form a seal. Since the supporting rod 12 can be pressed together, the width of the revolving groove 13a is slightly smaller than that of the supporting rod so that a press fit is obtained and the sealing effect guaranteed.

FIG. 7 shows a different annular flange 14 for holding the screen structure in FIG. 5. This annular flange 14 has a recess 14a in the circumference which holds the supporting rod 12. The supporting rod 12 is pressed against the recess 14a by a cover 17, which is bolted 18 to the annular flange 14, in such a way that the supporting rod 12 is pressed against the annular flange 14 to form a seal.

FIG. 8 shows an embodiment of a fractionation or screening structure, where the screening structure in the form of bars 6a is secured via spring elements 15 in a circumferential groove 16a of an annular flange 16. The spring element 15 absorbs the transverse forces Pi acting on the bars 6a and diverts them to the annular flange 16. The width and depth of the circumferential groove 16a is sized so that the bars can move freely inside the circumferential groove within the limits of the loads normally occurring in operation. It is useful to manufacture the spring element 15 from the same material as the bars and the annular flange, e.g. of stainless steel. Here, too, the bearing or support seal can be guaranteed by the spring element 15—shown symbolically—forming a positive fit with the circumferential groove or by a rotating, dense weld seam joining the screen structure and the annular flange.

All of the embodiments of the invention mentioned above are fractionation and screening devices in which a fractionation or screening structure is connected via a bearing or support to a rigid machine base, where the bearing or support has greater compliance than the fractionation or screening structure. The compliance of the bearing or support is guaranteed by supporting or spring elements that transmit the bearing or support forces and torques to the machine base.

While preferred embodiments have been shown and described, various modifications and substitutions may be made thereto without departing from the spirit and scope of the invention. Accordingly, it is to be understood that the present invention has been described by way of illustration and not limitation.

1. A fractionation or screening device for mounting a fractionation or screening structure on a rigid machine base, the fractionation or screening structure having a compliance, the fractionation or screening device comprising a bearing having a compliance greater than the compliance of the fractionation or screening structure.

2. The fractionation or screening device of claim 1 wherein the bearing comprises compliant supporting elements.

3. The fractionation or screening device of claim 2 wherein the supporting elements are composed of materials having a smaller E-module than the E-module of the material of the fractionation or screening structure.

4. The fractionation or screening device of claim 3 wherein the supporting elements are composed of flexible material.

5. The fractionation or screening device of claim 2 wherein the supporting elements are shaped to fit the fractionation or screening structure.

6. The fractionation or screening device of claim 2 wherein the supporting elements are spring elements.

7. The fractionation or screening device of claim 2 wherein the supporting elements are sealing elements.

8. The fractionation or screening device of claim 1 wherein the fractionation or screening structure comprises a screen basket, a bow-screen, a corrugated screen or a flat screen.

9. The fractionation or screening device of claim 4 wherein the supporting elements are composed of polymeric material.

10. The fractionation or screening device of claim 9 wherein the supporting elements are composed of rubber.

11. The fractionation or screening device of claim 2 wherein the supporting elements are shaped to be held with positive locking in a bearing element of the machine base.
